(19) United States
(12) Patent Application Publication
(10) Pub. No.: US 2005/0161426 A1
(43) Pub. Date: Jul. 28, 2005

(54) Image-recording apparatus and image-recording process

(75) Inventors: Yukihiro Ozaki, Kanagawa (JP); Atsushi Suganuma, Kanagawa (JP); Seiki Morita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD., Kanagawa (JP)

(21) Appl. No.: 10/976,304

(22) Filed: Oct. 29, 2004

(30) Foreign Application Priority Data
Oct. 29, 2003 (JP) 2003-369244

(51) Int. Cl. H01B 13/00

(52) U.S. Cl. 216/13; 117/103; 156/345.24

(57) ABSTRACT

An image-recording apparatus and image-recording process capable of suppressing mispositioning of recording of an image from an ideal position while correcting for mispositioning of the recording of the image in a case in which a recording medium is deformed to an arbitrary shape. When a wiring pattern is to be recorded on a PWB (printed wiring board) using raster data, deformation information representing a state of deformation of the PWB is acquired beforehand. On the basis of this deformation information, the raster data is converted such that the wiring pattern that is recorded will, after the deformation, have the same shape as the wiring pattern represented by the unconverted raster data. On the basis of the converted raster data, the wiring pattern is recorded at the PWB before the deformation.

### CROSS-REFERENCE TO RELATED APPLICATION

This application claims priority under 35 USC 119 from Japanese Patent Application No. 2003-369244, the disclosure of which is incorporated by reference herein.

### BACKGROUND OF THE INVENTION

1. Field of the Invention

The present invention relates to an image-recording apparatus and an image-recording process, and more particularly relates to an image-recording apparatus and image-recording process for deforming an image represented by image information, in accordance with deformation of a recording medium on which the image is to be recorded, and recording the image on the recording medium.

2. Description of the Related Art

Laser-scanning image-recording devices which are capable of recording patterns directly on substrates are known as devices for recording predetermined patterns on substrates such as printed wiring boards (hereinafter referred to as PWBs), flat panel displays (hereinafter referred to as FPDs) and the like.

In this kind of image-recording device, it is generally necessary to record the pattern at a position and size determined in advance.

However, patterns recorded on PWBs (wiring patterns) are progressively becoming finer in accordance with increases in density of mounting of components, and a problem has emerged with recording positions being offset due to expansion/contraction of substrates, which occurs in a pressing process which is usually performed in a heated state. Thus, in a case of, for example, a multi-layer printed wiring board, alignment of cavities formed in the substrates, such as through-holes and the like, with the patterns of the respective layers cannot be performed with high accuracy. Conseqently, there is a problem in that packing density of such PWBs cannot be raised.

With FPDs, substrate sizes are progressively becoming larger with a view to raising productivity, and a problem has emerged with picture positions being offset due to increases in expansion/contraction amounts of substrates through processes of heating. For example, in a case in which a color filter pattern is recorded, mispositioned recording of respective colors, R (red), G (green) and B (blue), is a problem.

In order to counter such problems, Japanese Patent Application (JP-A) No. 2000-122303 discloses a technology which moves a PWB in a sub-scanning direction while scanning a light beam in a main scanning direction and modulating the light beam in accordance with an image pattern, hence implementing recording of a plurality of surface patterns on PWBs. This technology detects positioning alignment information applied to the surfaces of the PWBs and, when converting from vector data to bitmap data, corrects for mispositioning of recording in accordance with the surface-applied positioning information.

However, with the technology of JP-A No. 2000-122303, there has been a problem in that, rather than the pattern of each layer being shifted out of position, if amounts of deformation of the PWBs are large, deformation amounts of the image patterns will be large and, in the PWBs that are ultimately produced, mispositioning from absolute dimension positions specified in advance for the image patterns (below referred to as ideal positions) may be large.

When positional offsets are large, mounting positions of electronic components that are to be mounted at the PWBs will be greatly offset from preferred positions. Consequently, it is difficult to automate mounting of these electronic components on the PWBs. Moreover, even if it is possible to mount the electronic components, it may be difficult to assemble the PWBs to device housings.

That is, at a device to which a PWB is to be assembled, it is assumed that offset amounts of mounting positions of electronic components on the PWB will be within a pre-specified range of offset tolerance, and electronic components, openings and the like which are to correspond with the electronic components on the PWB (for example, male connectors corresponding with female connectors, light detection elements corresponding with light emission elements and the like) are often provided. In such a case, if the offset amounts of the mounting positions of the electronic components exceed the tolerable offset amounts, it will be extremely difficult to assemble the PWB to the device housing.

### SUMMARY OF THE INVENTION

The present invention has been devised in order to eliminate the problems described above, and an object of the present invention is to provide an image-recording apparatus and image-recording process capable of suppressing mispositioning of recording of an image from an ideal position and correcting for mispositioning of the image in a case in which a recording medium is deformed to an arbitrary shape.

In order to achieve the object described above, an image-recording apparatus of a first aspect, in accordance with deformation of a recording medium at which an image represented by image information is to be recorded, converts the image and records the image at the recording medium. This image-recording apparatus includes: an acquisition section for preliminarily acquiring deformation information representing a state of deformation of the recording medium; a conversion section for converting the image information, in accordance with the deformation information acquired by the acquisition section, such that the image recorded at the recording medium will, after deformation, have the same shape as the image represented by the image information; and a recording section for, before deformation, recording the image at the recording medium on the basis of the image information that has been converted by the conversion section.

According to another aspect of the present invention, there is provided an image-recording method for, in accordance with deformation of a recording medium at which an image represented by image information is to be recorded, converting the image and recording the converted image at the recording medium, the method comprising the steps of: preliminarily acquiring deformation information representing a state of deformation of the recording medium; converting the image information, in accordance with the deformation information, such that the image recorded at the recording medium will, after deformation, have the same shape as the image represented by the image information; and recording the image at the recording medium before deformation on the basis of the image information that has been converted.

### BRIEF DESCRIPTION OF THE DRAWINGS

FIG. 1 is a perspective view showing the exterior of an image-recording apparatus relating to first and second embodiments.

FIG. 2 is a perspective view showing structure of a recording head of the image-recording apparatus relating to the embodiments.

FIG. 3A is a plan view showing exposed regions formed at a PWB.

FIG. 3B is a view showing an arrangement of exposure areas due to respective exposure heads.

FIG. 4 is a plan view showing a state of arrangement of dots of a recording element unit.

FIG. 5 is a block diagram of functions for performing control of exposure on the PWB at the image-recording apparatus relating to the embodiment.

FIG. 6 is a flowchart showing a processing flow at a time of test production of PWBs at the image-recording apparatus relating to the first embodiment.

FIG. 7 is a flowchart showing a processing flow at a time of mass production of PWBs at the image-recording apparatus relating to the first embodiment.

FIG. 8 is an explanatory view to accompany descriptions of counter-deformation processing relating to the embodiment.

FIG. 9 is another explanatory view to accompany descriptions of counter-deformation processing relating to the embodiment.

FIGS. 10A and 10B are explanatory views to accompany descriptions of operations of the image-recording apparatus relating to the embodiment.

FIG. 11 is an explanatory view to accompany descriptions of a variant example of the embodiment.

FIG. 12 is a flowchart showing a processing flow at a time of production of one lot of PWBs at the image-recording apparatus relating to the second embodiment.

FIG. 13 is a flowchart showing a processing flow at a time of execution of variation data calculation processing at the image-recording apparatus relating to the second embodiment.

FIG. 14 is a flowchart showing a processing flow at a time of execution of substrate production processing at the image-recording apparatus relating to the second embodiment.

FIG. 15 is a block diagram of a variant example of functions for performing control of the exposure on the PWB at the image-recording apparatus relating to the embodiments.

### DETAILED DESCRIPTION OF THE INVENTION

### First Embodiment

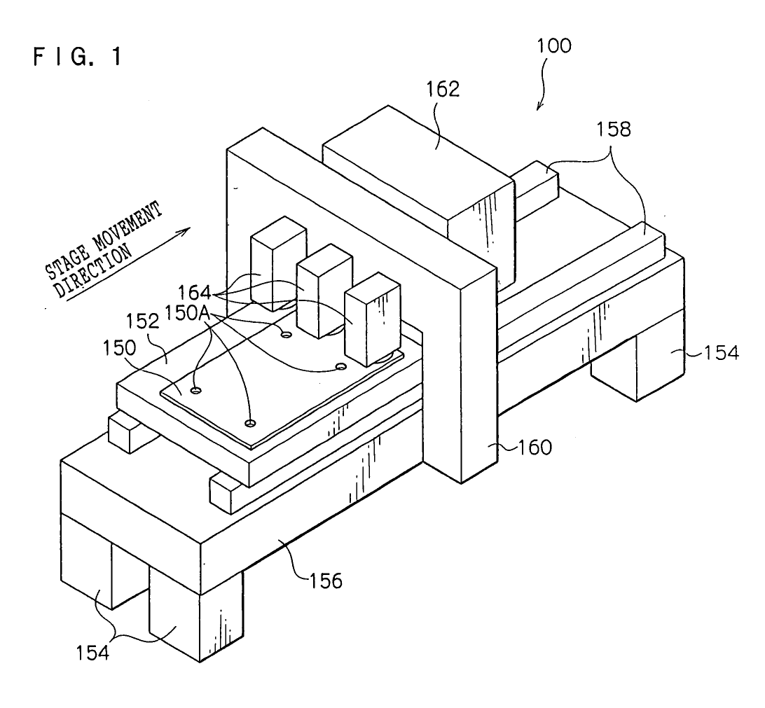

FIG. 1 shows a flathead-type image-recording apparatus 100 relating to a present embodiment.

The image-recording apparatus 100 is provided with a thick board-form setting pedestal 156, which is supported by four leg portions 154, and is provided with a flat board-form stage 152 with two guides 158, which extend in a stage movement direction, interposed between the setting pedestal 156 and the stage 152. The stage 152 is provided with a function for retaining a printed wiring board (PWB) 150 at a surface thereof by suction.

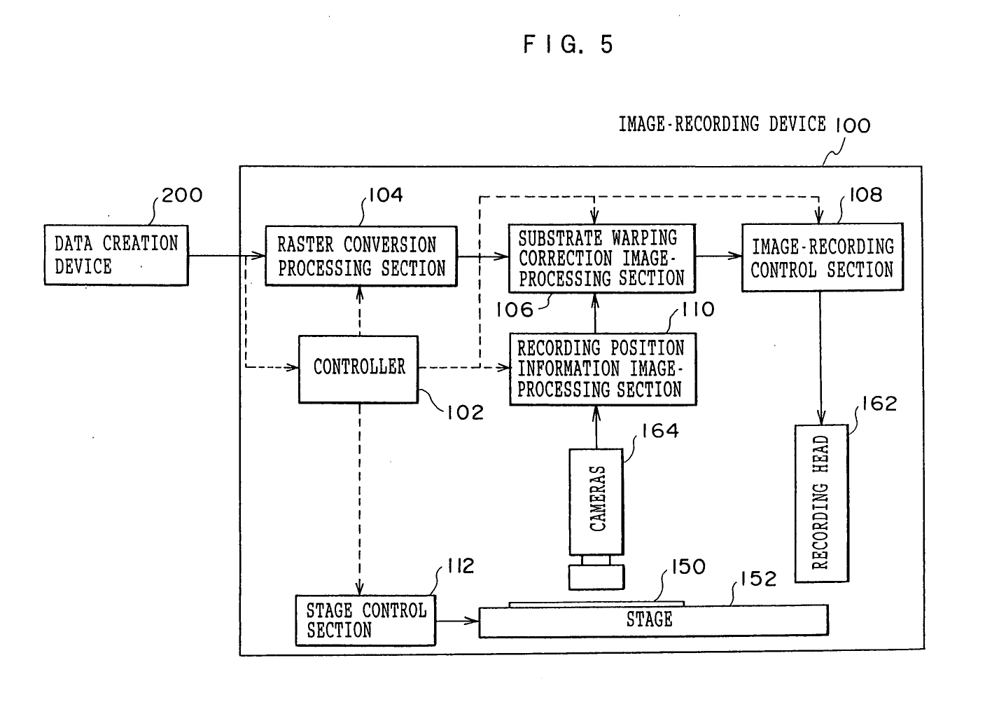

A longitudinal direction of the stage 152 is oriented in the stage movement direction, and the stage 152 is guided by the guides 158 and supported by the same so as to be reciprocally movable (scannable). At this image-recording apparatus 100, an unillustrated driving apparatus is provided for driving the stage 152 along the guides 158. The stage 152 is controlled for driving by a stage control section 112, which is described later (see FIG. 5), such that a movement speed (scanning speed) corresponds to a desired ratio of magnification in the direction of scanning.

At a central portion of the setting pedestal 156, an ‘n’-like gate 160 is provided so as to straddle a movement path of the stage 152. Respective end portions of the ‘n’-like gate 160 are fixed at two side faces of the setting pedestal 156. Sandwiching the gate 160, a recording head 162 is provided at one side, and a plurality (in the present embodiment, three) of cameras 164 are provided at the other side. The cameras 164 detect a leading end and a trailing end of the PWB 150 and positions of a plurality (in the present embodiment, four) of positioning holes 150A, which are circular in plan view and have been provided at the PWB 150 beforehand.

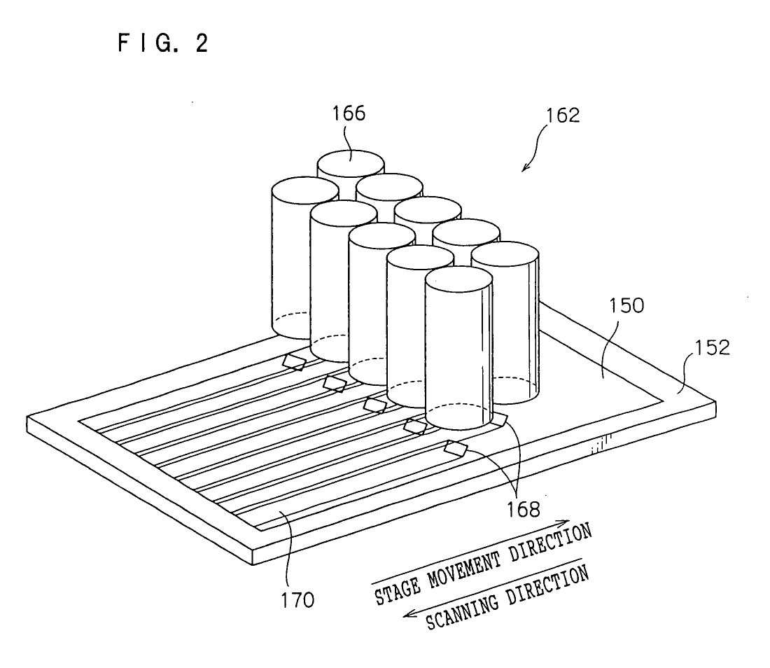

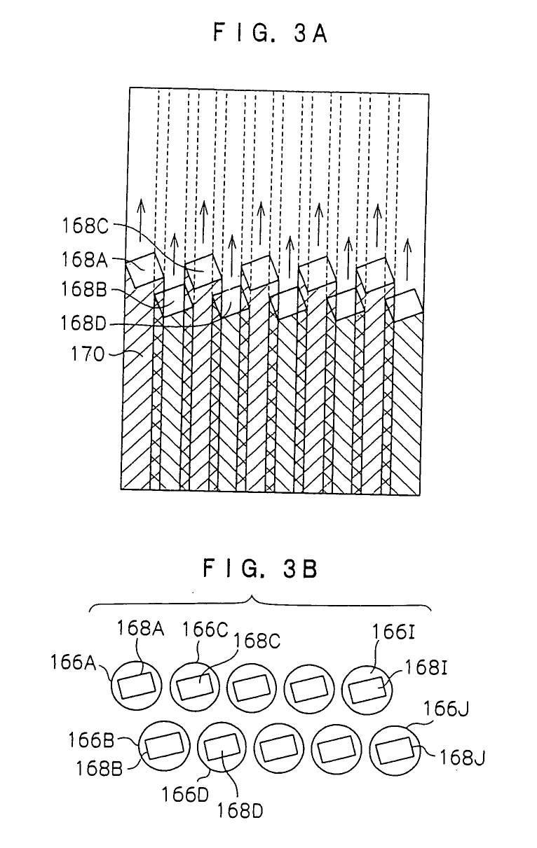

As shown in FIGS. 2 and 3B, the recording head 162 is equipped with a plurality of recording element units 166, which are arranged substantially in a matrix pattern with m rows and n columns (for example, two rows and five columns).

Image regions 168, which are regions exposed by the recording element units 166, have rectangular shapes with short sides thereof in a scanning direction, as shown in FIG. 2, and are angled relative to the scanning direction by a predetermined inclination angle θ. Thus, in accordance with movement of the stage 152, band-form exposed regions 170 are formed on the PWB 150 at the respective recording element units 166. Note that the scanning direction is a direction opposite to the stage movement direction, as shown in FIG. 2.

As shown in FIGS. 3A and 3B, in each row, the respective recording element units 166, which are arranged in a line, are disposed to be offset by a predetermined interval in a row arrangement direction (which interval is an integer (one in the present embodiment) multiple of the long dimension of an image region), such that the band-form exposed regions 170 are each partially superposed with the adjacent exposed regions 170. Thus, a portion that cannot be exposed between, for example, an image region 168A, which is disposed at a leftmost end of the first row, and an image region 168C, which is disposed adjacent and to the right of the image region 168A, is exposed by an image region 168B, which is disposed at a leftmost end of the second row. Similarly, a portion that cannot be exposed between the image region 168B and an image region 168D, which is disposed adjacent and to the right of the image region 168B, is exposed by the image region 168C.

At each of the recording element units 166, an irradiated light beam is controlled to ON and OFF at dot positions by an unillustrated digital micromirror device (DMD), which is a spatial light modulation device, and a pattern of binary dots (black/white) is exposed on the PWB 150. Density of each of pixels is represented by this plurality of dot patterns.

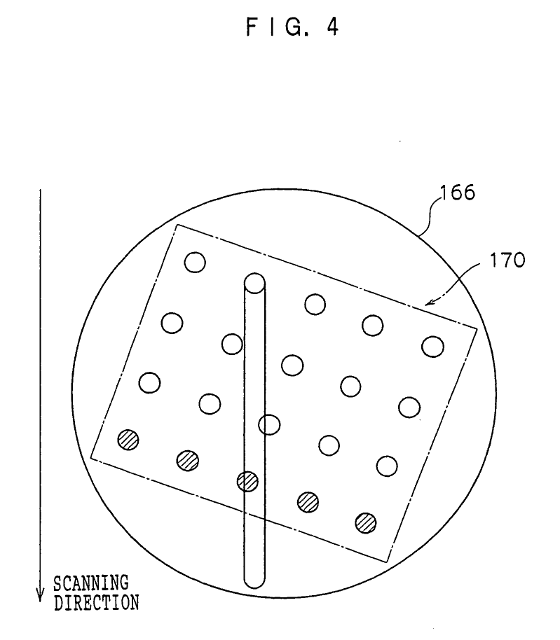

As shown in FIG. 4, the band-form exposed region 170 mentioned above (of each of the recording element units 166) is formed by twenty dots in a two-dimensional array (four dots by five dots).

Because this two-dimensionally arranged dot pattern is angled with respect to the scanning direction, each of dots arranged in the scanning direction passes between dots arranged in a direction intersecting the scanning direction. Namely, each dot in a row of the dots passes between dots in other rows of the dots. Therefore, it is possible to achieve an increase in resolution.

In a case in which there are dots which are not to be used, because of variations in adjustment of the angle of inclination—for example, the dots which are shaded in FIG. 4 are dots which are not used—portions of the DMD corresponding to such dots are constantly set to an OFF state.

Now, the image-recording apparatus 100 relating to the present embodiment is a device in which wiring patterns of PWBs 150 that are structured as multi-layer printed wiring boards are the subjects of recording. Below, an overall process for fabrication of the PWB 150 using the image-recording apparatus 100 will be briefly described.

First, a surface of the PWB 150 is coated with a photosensitive agent, and the PWB 150 is placed at a predetermined position on the stage 152 of the image-recording apparatus 100 (in the present embodiment, a substantially central position of the stage 152, as shown in FIG. 1). Hence, the PWB 150 is retained at the surface of the stage 152 by suction.

Next, scanning exposure is performed by the image-recording apparatus 100 on the upper face of the PWB 150, on the basis of image data representing a wiring pattern. Thus, an image (a latent image) of the wiring pattern is formed on the upper face of the PWB 150.

Then, development (removal of portions not exposed by the image-recording apparatus 100) and etching are carried out on the PWB 150 by an unillustrated apparatus. Thus, one layer of the multi-layer printed wiring board can be prepared.

Next, a substrate to structure a second layer is laminated on the surface at which the wiring pattern of the thus-created first layer of the PWB 150 has been formed, by a pressing process which presses with an unillustrated press-heating plate.

Subsequently, the processes described above (coating of a photosensitive agent, scanning exposure of a wiring pattern by the image-recording apparatus 100, development, etching, and stacking of a substrate) are repeated for the required number of layers. After etching of the last layer (a top layer) has finished, a predetermined finishing process is applied and the ultimate (or final) PWB 150 is completed.

Now, as mentioned earlier, the plurality (four in the present embodiment) of positioning holes 150A are provided at predetermined positions of the PWB 150. However, positions thereof will often be offset in arbitrary directions from the predetermined positions by expansion/contraction of the PWB 150, which occurs during the aforementioned pressing process.

At the image-recording apparatus 100 relating to the present embodiment, the PWBs 150 are fabricated in two stages, test production and mass production.

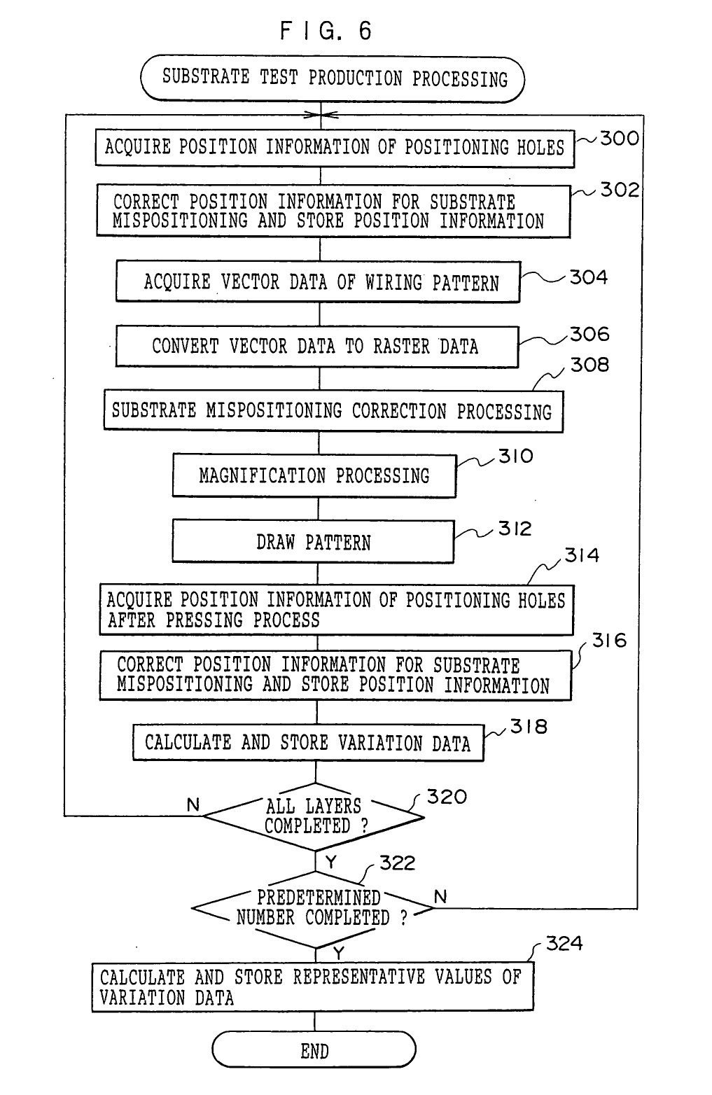

Next, operation of the image-recording apparatus 100 at a time of test production of the PWBs 150 will be described in detail with reference to FIGS. 5 and 6. Herein, FIG. 5 is a block diagram of functions for performing control of exposure on the PWB 150 at the image-recording apparatus 100, and FIG. 6 is a flowchart showing a processing flow at the time of test production at the image-recording apparatus 100.

First, the first layer of the PWB 150, whose surface has been coated with the photosensitive agent, is placed at a predetermined position on the stage 152 of the image-recording apparatus 100. Hence, the PWB 150 is retained on the surface of the stage 152 by suction.

Next, a controller 102, which administers overall operations of the image-recording apparatus 100, implements control of the stage control section 112 for moving the stage 152, with the aforementioned unillustrated driving apparatus, in the scanning direction at a movement speed (scanning speed) corresponding to a desired magnification ratio. Accordingly, movement of the PWB 150, which has been placed on the stage 152 but has not yet been exposed with a wiring pattern, in the stage movement direction from a downstream-most position (the position shown in FIG. 1) commences.

Accordingly, image data representing images of the PWB 150, which are captured by the plurality (three in the present embodiment) of cameras 164, is sequentially inputted into a recording position information image-processing section 110. On the basis of this image data, the recording position information image-processing section 110 detects positions of the positioning holes 150A of the PWB 150 placed on the stage 152, acquires position information representing these positions, and outputs the position information to a substrate warping correction image-processing section 106 (step 300 in FIG. 6).

Here, detection of the positioning holes 150A of the PWB 150 can be achieved by pattern-matching of the images represented by the image data inputted from the cameras 164 with images represented by image data of a reference PWB 150. The image data of the reference PWB 150, which has not been through the aforementioned pressing process, has been obtained by image capture by the cameras 164 of the reference PWB 150 and stored in unillustrated memory provided at the recording position information image-processing section 110.

Information representing positions of the positioning holes 150A in the reference PWB 150 is also stored in the unillustrated memory beforehand. It is possible to apply a process for detecting the positioning holes 150A of the PWB 150 placed on the stage 152 by, for example, extracting images of circles, which is the shape of the positioning holes 150A, from, of the image data inputted from the cameras 164, image data corresponding to regions in predetermined ranges containing the positions of the positioning holes 150A as represented by the stored information.

The substrate warping correction image-processing section 106, to which the position information is inputted from the recording position information image-processing section 110, performs correction, for countering offsetting of a position of placement of the PWB 150 on the stage 152, on the position information and then stores the position information in unillustrated storing means (step 302). In the present embodiment, this correction of the position information is carried out by finding displacement amounts in two directions (the scanning direction and the direction intersecting the scanning direction) that are capable of making a position central to the positions of the four positioning holes 150A represented by the position information coincide with a pre-specified reference position, and correcting such that the respective positions of the positioning holes 150A represented by the position information are moved in the two directions by these displacement amounts.

Thereafter, the controller 102 returns the PWB 150 to the downstream-most position (the position shown in FIG. 1) by controlling the stage control section 112 such that the stage 152 is moved in the direction opposite to the aforementioned stage scanning direction.

Meanwhile, vector data, which represents a wiring pattern to be exposed and recorded at the PWB 150, is inputted into a raster conversion processing section 104. This vector data has been prepared by a data preparation device 200, which is structured to include a CAM (computer-aided manufacturing) station.

Accordingly, the raster conversion processing section 104 acquires this vector data (step 304), converts the vector data to raster data (bitmap data), and outputs the raster data to the substrate warping correction image-processing section 106 (step 306).

In accordance therewith, the substrate warping correction image-processing section 106 performs correction on the inputted raster data in order to deal with offsetting of the placement position of the PWB 150 on the stage 152, and then stores the corrected data in the unillustrated storing means (step 308). In the present embodiment, this correction of the raster data is performed by correcting so as to displace the position of the wiring pattern represented by the raster data in the scanning direction and the direction intersecting the scanning direction by the displacement amounts found in the processing of step 302.

Then, the substrate warping correction image-processing section 106 performs magnification processing on the corrected raster data such that the wiring pattern represented by the raster data is magnified by pre-specified magnification ratios in the scanning direction and the direction intersecting the scanning direction (step 310). The ratios applied in this magnification processing are determined empirically in accordance with amounts of deformation of the PWB 150 that will ultimately be obtained. Deformation amount ratios, for the scanning direction and the direction intersecting the scanning direction, are empirically determined from previous results of production of PWBs with the magnification ratios being taken to be ‘1’ when there is no deformation of the PWB 150.

Meanwhile, the aforementioned vector data from the data preparation device 200 is also inputted into the controller 102.

In accordance therewith, on the basis of the vector data, the controller 102 implements control of the stage control section 112 for moving the stage 152, with the unillustrated driving apparatus, in the scanning direction at a movement speed (scanning speed) corresponding to the desired magnification ratio. Hence, the PWB 150, which has been placed on the stage 152 and is yet to be exposed with the wiring pattern, starts to move in the stage movement direction from the downstream-most position (the position shown in FIG. 1).

An image-recording control section 108 uses the magnification-processed raster data provided from the substrate warping correction image-processing section 106 by the processing of step 310 to generate on/off data of the recording element units 166, which is final image data. Then, using the on/off data, the DMDs of the recording element units 166 of the recording head 162 are controlled in synchronization with the movement of the stage 152, and image recording of the wiring pattern is executed. Thus, an image representing the wiring pattern is exposed onto the PWB 150 (step 312).

Subsequently, as described earlier, development (removal of portions not exposed by the image-recording apparatus 100) and etching are applied to the wiring pattern-exposed PWB 150 by unillustrated apparatus. Thus, one layer of a multi-layer printed wiring board can be produced.

Next, a substrate structuring a second layer is laminated on the surface of the thus-produced first layer of the PWB 150 at which the wiring pattern has been formed, by the pressing process which presses with an unillustrated press-heating plate, and the photosensitive agent is coated onto a top surface.

Then, this PWB 150 is placed at the predetermined position on the stage 152 of the image-recording apparatus 100. Hence, the PWB 150 is retained at the surface of the stage 152 by suction.

Thereafter, similarly to step 300 and step 302, position information representing the positions of the positioning holes 150A of the PWB 150 is acquired and correction for countering mispositioning of the PWB 150 on the stage 152 is performed, after which the corrected position data is stored in the unillustrated storing means (step 314 and step 316).

Then, the substrate warping correction image-processing section 106 calculates offset amounts (below referred to as “variation data”) in the two directions (the scanning direction and the direction intersecting the scanning direction) of the positions of the positioning holes 150A, as represented by the position information stored in the unillustrated storing means by the processing of the above-described step 316, relative to the respective positions of the positioning holes 150A, as represented by the position information stored in the unillustrated storing means by the processing of the above-described step 302, for each of the positioning holes 150A and stores this variation data in the unillustrated storing means (step 318).

The processing of steps 300 to 318 described above is repeated for the required number of layers (step 320). Accordingly, a number of sets of variation data one less than the number of layers structuring the PWB 150 is obtained and stored in the unillustrated storing means.

Hence, variation data for a predetermined number of the PWBs 150 is acquired by carrying out the processing described above for each of these PWBs 150 (step 322). Representative values of the variation data acquired for the respective PWBs 150 are calculated for each layer of stacking and for each of the positioning holes 150A, and are stored in the unillustrated storing mains (step 324). In the present embodiment, the above-mentioned representative values of the variation data are calculated as arithmetic mean values of the variation data for each layer of stacking and each positioning hole 150A. However, the present invention is not limited thus, and it is also possible to calculate weighted averages of the variation data or to calculate median values of the variation data.

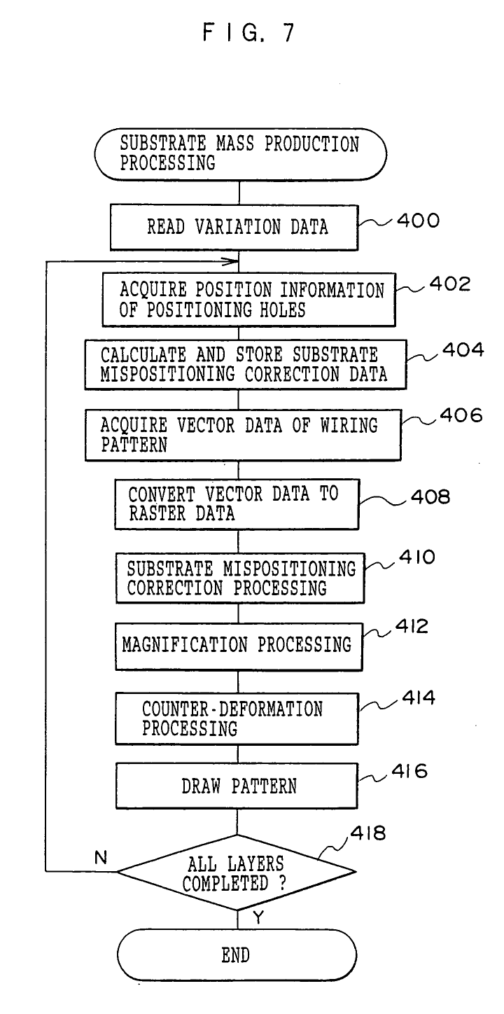

Next, operation at a time of mass production of the PWBs 150 at the image-recording apparatus 100 will be described in detail with reference to FIGS. 5 and 7. FIG. 7 is a flowchart showing a processing flow at the time of mass production at the image-recording apparatus 100.

First, the substrate warping correction image-processing section 106 reads out the representative values of variation data for each lamination and each positioning hole 150A, which have been stored by the processing at the time of test production as shown in FIG. 6, from the unillustrated storing means (step 400).

Meanwhile, the first layer of the PWB 150, at the surface of which the photosensitive agent has been applied, is placed at the predetermined position on the stage 152 of the image-recording apparatus 100. Hence, the PWB 150 is retained on the surface of the stage 152 by suction.

Next, the controller 102 implements control of the stage control section 112 for moving the stage 152, using the unillustrated driving apparatus, in the scanning direction at the movement speed (scanning speed) corresponding to the desired magnification ratio. As a result, the PWB 150 placed on the stage 152 but yet to be exposed with the wiring pattern starts to move in the stage movement direction from the downstream-most position (the position shown in FIG. 1).

In accordance therewith, image data representing images of the PWB 150, which are captured by the plurality (three in the present embodiment) of cameras 164, is sequentially inputted into the recording position information image-processing section 110. On the basis of this image data, the recording position information image-processing section 110 detects positions of the positioning holes 150A of the PWB 150 that has been placed on the stage 152 by similar processing to that of step 300 shown in FIG. 6, acquires position information representing these positions, and outputs the position information to the substrate warping correction image-processing section 106 (step 402).

The substrate warping correction image-processing section 106 to which the position information has been inputted calculates correction data for countering offsetting of the placement position of the PWB 150 on the stage 152 (below referred to as “substrate mispositioning correction data”), and stores this correction data in the unillustrated storing means (step 404). In the present embodiment, the calculation of the substrate mispositioning correction data, similarly to the method of calculation of displacement amounts that is employed in the processing of correction for countering offsetting of the placement position of the PWB 150 in step 302 of FIG. 6, is carried out by finding displacement amounts in the two directions (the scanning direction and the direction intersecting the scanning direction) that are capable of making a position central to the positions of the four positioning holes 150A represented by the position information coincide with a pre-specified reference position (the same reference position as that utilized in step 302 of FIG. 6).

Meanwhile, vector data which represents a wiring pattern to be exposed and recorded at the PWB 150, which has been prepared by the data preparation device 200, is inputted into the raster conversion processing section 104.

Accordingly, the raster conversion processing section 104 acquires this vector data (step 406), converts the vector data to raster data (bitmap data), and outputs the raster data to the substrate warping correction image-processing section 106 (step 408).

In accordance therewith, the substrate warping correction image-processing section 106 performs correction on the inputted raster data in order to deal with offsetting of the placement position of the PWB 150 on the stage 152, and then stores the corrected data in the unillustrated storing means (step 410). In the present embodiment, this correction of the raster data is performed by reading the substrate mispositioning correction data that was stored by the above-described processing of step 404 from the unillustrated storing means, and correcting so as to displace the position of the wiring pattern represented by the raster data in the scanning direction and the direction intersecting the scanning direction by the displacement amounts represented by the substrate mispositioning correction data.

Then, the substrate warping correction image-processing section 106 performs magnification processing on the corrected raster data such that the wiring pattern represented by the raster data is magnified by the pre-specified magnification ratios (the same magnification ratios as those applied in step 310 of FIG. 6) in the scanning direction and the direction intersecting the scanning direction (step 412).

The substrate warping correction image-processing section 106 further performs counter-deformation processing to convert the magnification-processed raster data such that, after deformation by the aforementioned pressing process and the like, the wiring pattern recorded at the PWB 150 will have the same shape as the wiring pattern represented by the raster data (step 414).

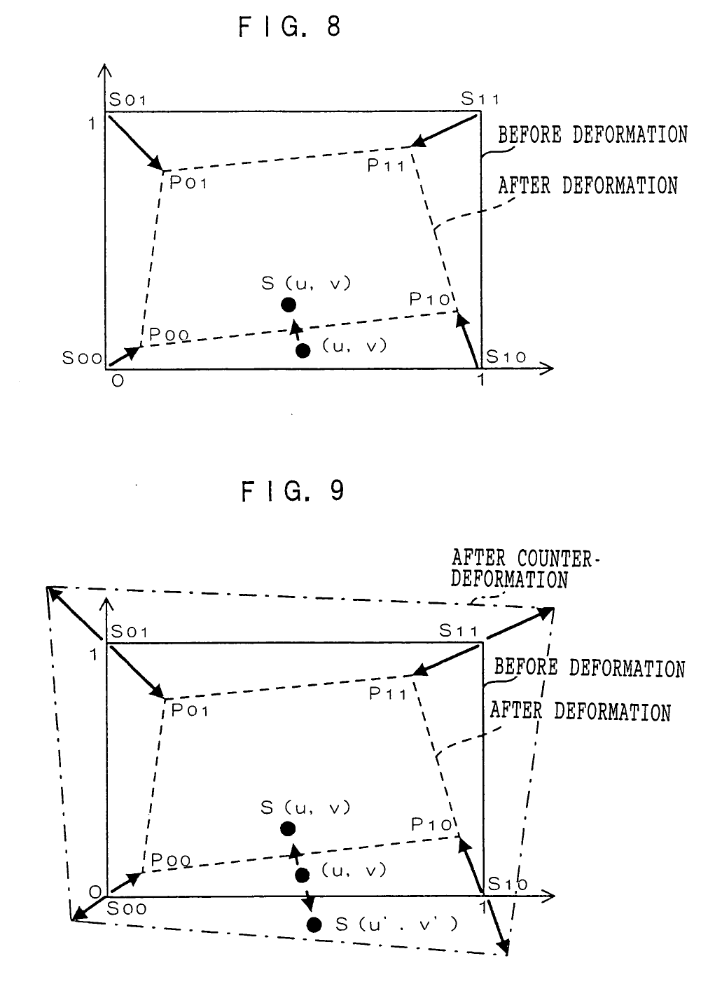

Below, the counter-deformation processing will be described. Here, as an example, a case will be described in which, as shown in FIG. 8, the positions of a plurality (four in the present embodiment) of reference marks (in the present embodiment, the positioning holes 150A) of a recording medium in an idealized case (before deformation) are the positions shown by the points S₀₀, S₁₀, S₁₁ and S₀₁, and positions of the respective reference marks after deformation are the positions shown by the points P₀₀, P₁₀, P₁₁ and P₀₁. In the idealized case, deformation has not occurred at the recording medium (in the present embodiment, the PWB 150) at which an image (in the present embodiment, the wiring pattern) is to be recorded.

First, a deformation method (herein, the FFD (free form deformation) method) which deforms a quadrilateral structured with the points S₀₀, S₁₀, S₁₁ and S₀₁ as corner points thereof to a quadrilateral with the points P₀₀, P₁₀, P₁₁ and P₀₁ as corner points thereof will be described. The respective points Pij (in which i=0 or 1 and j=0 or 1) which are utilized here are referred to as control points.

As shown in FIG. 8, coordinates (u,v) of arbitrary points in the pre-deformation image (here, 0≦u≦1 and 0≦v≦1) correspond with coordinates S(u,v) of the post-deformation image. With the FFD method, the coordinates S(u,v) can be found by the following equation (1). Note that x co-ordinates and y co-ordinates are here subjected to normalization to respective lengths of the pre-deformation co-ordinate system.

$$S ( u , v ) = {\sum }_{j = 0}^{1} {\sum }_{i = 0}^{1} PijBi ( u ) Bj ( v ) \qquad Equation ( 1 )$$

Herein, B₀(u)=1−u and B₁(u)=u, and equation 1 can be expanded as shown in equation (2).
S(u,v)=P₀₀(1−u)·(1−v)+P₀₁(1−u)·v+P₁₀u·(1−v)+P₁₁u·v Equation (2)

It is possible, utilizing this previously known deformation processing technique, to convert an image formed in a rectangular shape in a pre-deformation co-ordinate space to an image formed in a quadrilateral shape (a deformed quadrilateral) in a post-deformation co-ordinate space.

Specifically, as pixel data for a point S(u,v), pixel data of a point (u,v) in the pre-deformation image may be used. Here, the co-ordinates S(u,v) may have values to the right of the decimal point (or fractional values with respect to pixel counts), but it is possible, by rounding off, to obtain the coordinates of the nearest pixel. Further, as necessary, pixel data for a particular pixel may be obtained by interpolation processing, such as linear interpolation processing or the like, from pixel data of a plurality of points near that particular point. Note that such processing for calculation of pixel data is referred to as “nearest neighbor interpolation processing”.

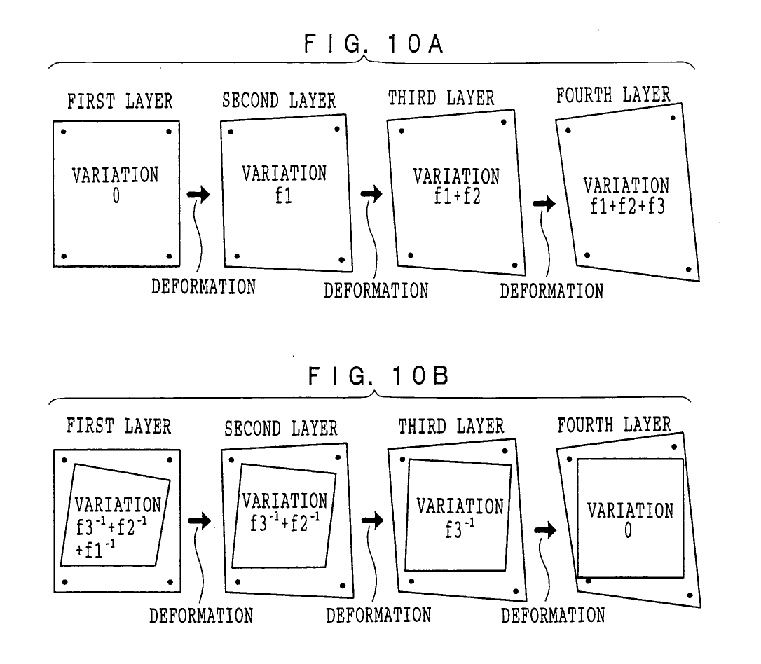

Thus, in a case in which the deformation processing technique described above is employed for the counter-deformation processing relating to the present embodiment, it is possible to implement the counter-deformation processing by varying the values of u and v and carrying out conversions for all pixels. This conversion employs pixel data of a point (u,v) in the pre-deformation image as pixel data of a point S(u′,v′), which, as is shown by the example in FIG. 9, is located at a position with point symmetry with the point S(u,v) about the point (u,v).

Here, representative values of the variation data of each layer of lamination and each positioning hole 150A, which is read by the processing of the aforementioned step 400, (amounts of offsetting of positions of the positioning holes 150A) are calculated for the respective positioning holes 150A to obtain composite mispositioning amounts. Values which represent final positions, after deformation, of the respective positioning holes 150A are obtained by displacing the positions of the positioning holes 150A that correspond to the idealized case, in which the PWB 150 is not deformed, by these composite mispositioning amounts, in the scanning direction and the direction intersecting the scanning direction. These values representing final positions are employed as values of the points Pij (where i=0 or 1 and j=0 or 1), which are the control points.

Meanwhile, the aforementioned vector data is also inputted to the controller 102 from the data preparation device 200.

In accordance therewith, on the basis of this vector data, the controller 102 implements control of the stage control section 112 for moving the stage 152, using the unillustrated driving apparatus, in the scanning direction at the movement speed (scanning speed) corresponding to the desired magnification ratio. As a result, the PWB 150, which has been placed on the stage 152 but has not yet been exposed with the wiring pattern, starts to move in the stage movement direction from the downstream-most position (the position shown in FIG. 1).

The image-recording control section 108 uses the counter-deformation-processed raster data, which is provided from the substrate warping correction image-processing section 106 by the processing of step 414 described above, to generate on/off data for the respective recording element units 166, which is final image data. Hence, using this on/off data, the DMDs of the respective recording element units 166 of the recording head 162 are controlled in synchronization with the movement of the stage 152, and image-recording of the wiring pattern is implemented. Thus, an image representing the wiring pattern is exposed onto the PWB 150 (step 416).

Subsequently, as described earlier, development (removal of portions not exposed by the image-recording apparatus 100) and etching are applied by the unillustrated apparatus to the PWB 150 which has been exposed with the wiring pattern. Thus, one layer of a multi-layer printed wiring board can be produced.

Then, a substrate for structuring a second layer is laminated on the surface of the thus-produced first layer of the PWB 150, at which surface the wiring pattern has been formed, by the pressing process which presses with the unillustrated press-heating plate.

Subsequently, the processes described above (coating of the photosensitive agent, scanning exposure of a wiring pattern by the image-recording apparatus 100, development, etching and substrate stacking) are repeated for the required number of layers.

Accordingly, the image-recording apparatus 100 repeats the processing of steps 402 to 416 described above for the required number of layers (step 418). After etching of the last layer (a top layer) has finished, the predetermined finishing process is applied and the ultimate PWB 150 is completed.

Here, when the processes of steps 402 to 416 are being repeatedly performed, in step 414, representative values are calculated for the respective positioning holes 150A to obtain composite mispositioning amounts. These representative values are calculated by excluding, of the representative values of the variation data for each layer of stacking and each positioning hole 150A that have been read out by the processing of step 400 (the amounts of offsetting of the positions of the positioning holes 150A), representative values up to the values for an n-th layer, where n is the number of the current layer. Values which represent ultimate post-deformation positions of the respective positioning holes 150A are obtained by displacing the positions of the positioning holes 150A that correspond to the idealized case, in which the PWB 150 is not deformed, by these composite mispositioning amounts, in the scanning direction and the direction intersecting the scanning direction. These values representing post-deformation positions of the positioning holes 150A are employed as the values of the Points Pij (where i=0 or 1 and j=0 or 1), which are the control points.

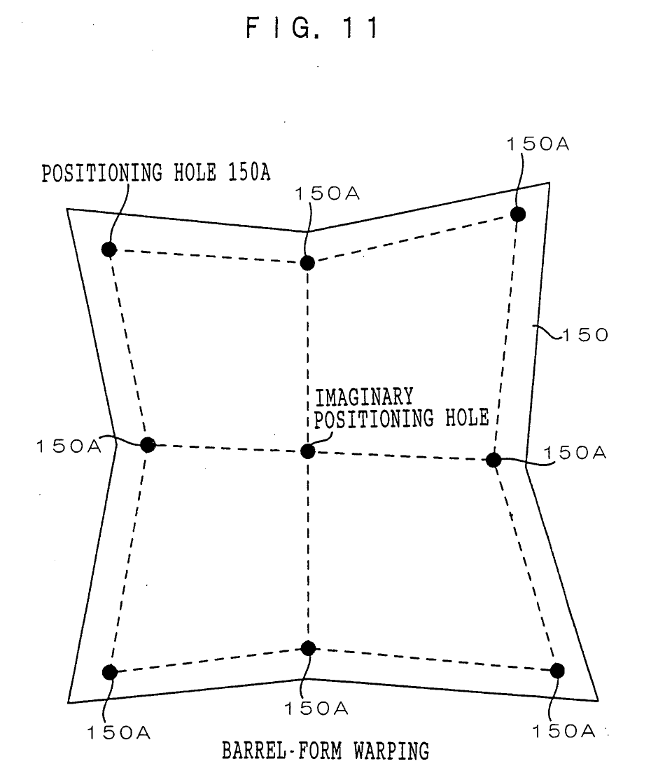

For example, in a case of producing a PWB with a four-layer structure, as shown by the example in FIG. 10A, variation data f1, which serves as variation data after lamination of the second layer, variation data f2, which serves as variation data after lamination of the third layer, and variation data f3, which serves as variation data after lamination of the fourth layer, may be respectively obtained by the processing at the time of test production as described earlier (see FIG. 6). In the processing at the time of mass production described above (see FIG. 7), as shown in FIG. 10B, a wiring pattern of the first layer is counter-deformed and recorded in accordance with ultimate variations of the PWB 150, which are obtained on the basis of all of the variation data (variation data sets f1 to f3), a wiring pattern of the second layer is counter-deformed and recorded in accordance with variations of the PWB 150 which are obtained on the basis of the variation data excluding the variation data f1 (i.e., variation data sets f2 and f3), a wiring pattern of the third layer is counter-deformed and recorded in accordance with variations of the PWB 150 which are obtained on the basis of the variation data excluding the variation data f1 and the variation data f2 (i.e., variation data f3), and a wiring pattern of the fourth layer is recorded without deformation.

Here, deformation of the PWB 150 is repeated at the time of lamination of each layer. Therefore, in consequence, offsetting of positions of recording of the wiring patterns that are recorded at the respective layers from ideal positions thereof is suppressed, while offsetting of positions of recording between the respective layers when the PWB 150 is being deformed to arbitrary shapes can be eliminated.

As has been described above, in the present embodiment, in accordance with deformation of a recording medium (here, the PWB 150) at which an image (here, a wiring pattern) represented by image information (here, raster data) is to be recorded, the image is deformed and recorded on the recording medium. At this time, deformation information (here, the variation data) representing a state of deformation of the recording medium is preliminarily acquired. On the basis of this deformation information, the image information is converted such that, after deformation, the image recorded on the recording medium will have the same shape as the image represented by the image information. The image is recorded on the recording medium, before deformation, on the basis of the converted image information. Thus, mispositioning of recording from an ideal position of the image is suppressed and it is possible to correct for mispositioning of recording of the image when the recording medium is deformed to an arbitrary shape.

Further, in the present embodiment, information of the deformation of the recording medium after lamination of each layer of the recording medium is preliminarily acquired. For each of sets of image information, which are subjects of recording onto the plurality of layers of the recording medium, the image information is converted, on the basis of the acquired deformation information of each lamination of the recording medium, such that the images recorded at the recording medium that is ultimately obtained will have the same shapes as the images represented by the sets of image information. At each layer of the recording medium, on the basis of the corresponding converted image information, the image is recorded at the recording medium before any subsequent deformations. Thus, in a case in which the ultimate recording medium is produced by plurally laminating the recording medium and, at each lamination of the recording medium, the recording medium is deformed after the lamination, mispositioning of recording from ideal positions of the images is suppressed and it is possible to correct for mispositioning of recording of the images when the recording medium is deformed to an arbitrary shape.

Further again, in the present embodiment, a plurality of reference marks (here, the positioning holes 150A) are provided in advance at predetermined positions of the recording medium. Information representing directions and amounts of shifting of positions of the reference marks between the recording medium before deformation and the recording medium after deformation is acquired to serve as the deformation information. Thus, the deformation information can be acquired with ease.

Further yet, in the present embodiment, because marks which are provided in advance for positioning when an image is to be recorded on the recording medium are utilized as the reference marks of the present invention, there is no need to provide new means for forming the reference marks, and it is possible to realize the present invention with ease and at low cost.

Further still, in the present embodiment, the positioning holes 150A which are utilized as the reference marks of the present invention are provided at vicinities of outer peripheral portions of the recording medium. Therefore, it is possible to deal with deformation of the whole of an image recording region of the recording medium.

Further yet again, in the present embodiment, the image information is converted in accordance with the FFD method. Thus, rapidity of the conversion processing can be expected. Specifically, if v is set to a fixed value, equation (1) according to the FFD method is a linear function of u. Therefore, when v is specified, an initial value (a starting point) and increments (i.e., increments corresponding to increments of u) can be easily found. Making use of this fact, subsequent calculations can just be simple arithmetic calculations, and rapidity of calculation processing can be expected.

In particular, in the present embodiment, the recording medium is a printed wiring board which is subjected to an etching process and a pressing process when recording of the image has been performed, and the image information represents a wiring pattern to be formed at the printed wiring board. Thus, mispositioning of recording from an ideal position of the wiring pattern is suppressed, and it is possible to correct for mispositioning of recording of the wiring pattern when the printed wiring board is deformed to an arbitrary shape.

Moreover, in the present embodiment, the counter-deformation processing is carried out on raster data, which is simpler in structure than vector data. Therefore, in comparison to a case of carrying out counter-deformation processing on vector data, it is possible to correct for mispositioning of recording with greater ease.

### Second Embodiment

For this second embodiment, a variant example is described which is a case in which the present invention is applied, for a sequential production process which successively produces a plurality of PWBs (herein, a process of production of one lot of PWBs), to a case in which variation data is acquired from an initial predetermined number of the PWBs and this variation data is used for producing the rest of the PWBs. Note that structure of an image-recording apparatus relating to this second embodiment is the same as the image-recording apparatus 100 relating to the first embodiment (see FIGS. 1 to 5), and descriptions thereof are not given here.

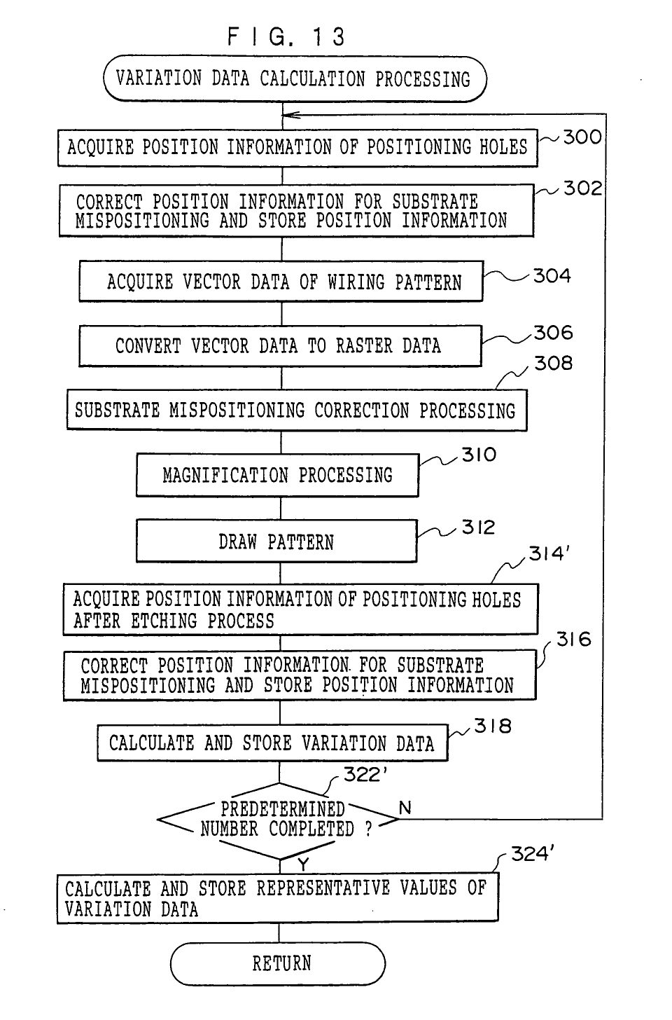

Herebelow, operations at a time of production of one lot of the PWBs 150 at the image-recording apparatus 100 relating to this second embodiment will be described in detail with reference to FIGS. 5 and 12. FIG. 12 is a flowchart showing a processing flow at the time of production of one lot of the PWBs 150 at the image-recording apparatus 100 relating to the present embodiment.

Here, in the image-recording apparatus 100 relating to the present embodiment, variation data calculation processing is executed first (step 500).

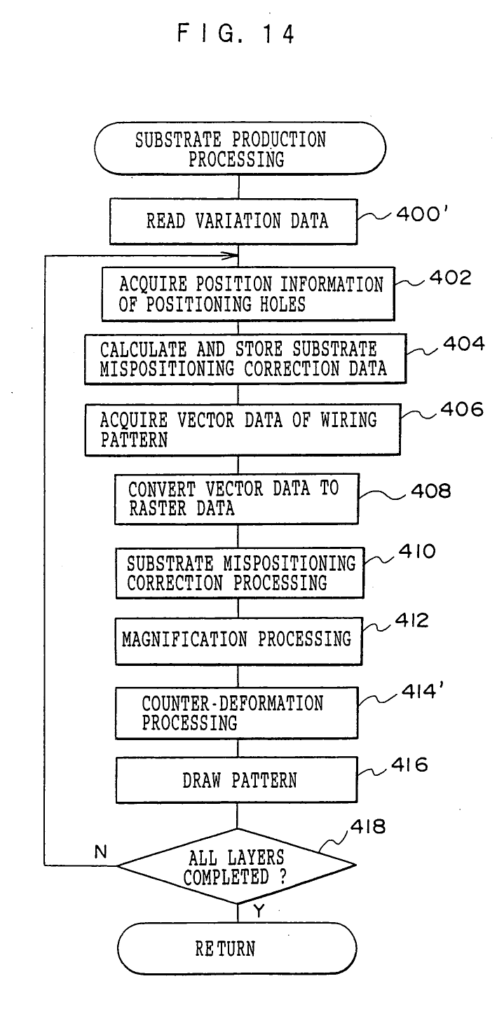

The variation data calculation processing will now be described in detail with reference to FIG. 13. FIG. 13 is a flowchart showing a processing flow of the image-recording apparatus 100 at the time of execution of the variation data calculation processing. Here, this variation data calculation processing carries out processing substantially the same as the processing of the flowchart shown in FIG. 6. Thus, steps in FIG. 13 that carry out processing the same as in FIG. 6 are assigned the same step numbers as in FIG. 6, and descriptions thereof are largely omitted.

When an image representing a wiring pattern is exposed at the PWB 150 by the processing of step 312 of FIG. 13, development (removal of portions not exposed by the image-recording apparatus 100) and etching are performed by unillustrated apparatus on the PWB 150 after recording of the wiring pattern. Thus, one layer of a multi-layer printed wiring board can be prepared.

Then, the PWB 150 of which one layer has been prepared is placed at the predetermined position on the stage 152 of the image-recording apparatus 100. Hence, the PWB 150 is retained at the surface of the stage 152 by suction.

Thereafter, similarly to step 300 and step 302, position information representing the positions of the positioning holes 150A of the PWB 150 is acquired and correction for countering mispositioning of the PWB 150 on the stage 152 is performed on the position information, after which the corrected position information is stored in the unillustrated storing means (step 314′ and step 316).

Then, the substrate warping correction image-processing section 106 calculates offset amounts (below referred to as “variation data”) in the two directions (the scanning direction and the direction intersecting the scanning direction) of the positions of the positioning holes 150A, as represented by the position information stored in the unillustrated storing means by the processing of the above-mentioned step 316, relative to the respective positions of the positioning holes 150A as represented by the position information stored in the unillustrated storing means by the processing of step 302, for each of the positioning holes 150A and stores this variation data in the unillustrated storing means (step 318).

By carrying out the processing described above for a predetermined number of layers (herein, five layers) of the PWB 150, variation data is acquired for each PWB 150 (step 322′). Representative values of the variation data acquired for the respective PWBs 150 are calculated for each of the positioning holes 150A and stored in the unillustrated storing means (step 324′). In the present embodiment, these representative values of the variation data are calculated as arithmetic mean values of the variation data for each positioning hole 150A. However, the present invention is not limited thus and it is also possible to calculate weighted averages of the variation data or to calculate median values of the variation data.

When variation data which represents a state of deformation of the PWB 150 just after the etching has finished has been calculated by the processing described above, the image-recording apparatus 100 relating to the present embodiment executes substrate production processing (step 502 in FIG. 12).

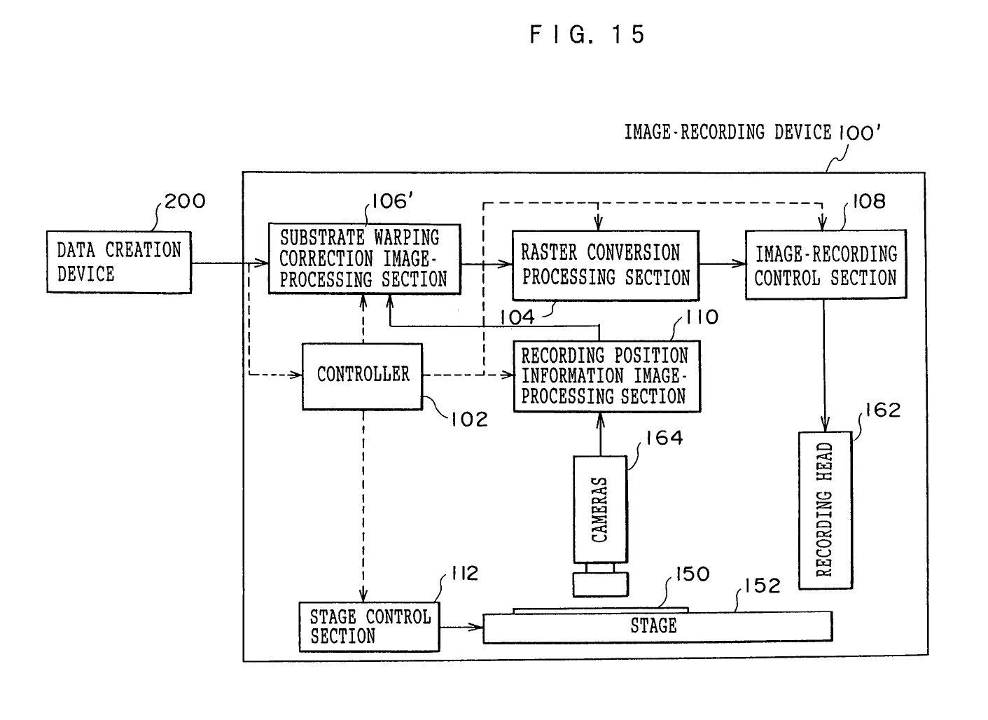

The substrate production processing will now be described in detail with reference to FIG. 14. FIG. 14 is a flowchart showing a processing flow of the image-recording apparatus 100 at the time of execution of the substrate production processing. Here, this substrate production processing performs processing substantially the same as the processing of the flowchart shown in FIG. 7. Thus, steps in FIG. 14 that carry out processing the same as in FIG. 7 are assigned the same step numbers as in FIG. 7, and descriptions thereof are largely omitted.

First, the substrate warping correction image-processing section 106 reads out the representative values of variation data for the respective positioning holes 150A, which have been stored by the variation data calculation processing shown in FIG. 13, from the unillustrated storing means (step 400′).

Subsequently, the substrate warping correction image-processing section 106 performs counterreformation processing to convert the raster data that has been magnification-processed by step 412 such that, after deformation by the pressing process and the like, the wiring pattern recorded at the PWB 150 will have the same shape as the wiring pattern represented by the raster data (step 414′).

Now, a technique of counter-deformation processing that is performed here is similar to the technique employed in the image-recording apparatus 100 relating to the above-described first embodiment (a counter-deformation processing technique using the FFD method). The values which represent final positions, after deformation, of the respective positioning holes 150A are obtained by displacing the positions of the positioning holes 150A that correspond to the idealized case, in which the PWB 150 is not deformed, in the scanning direction and the direction intersecting the scanning direction by mispositioning amounts, and these values representing final positions are employed as values of the points Pij (where i=0 or 1 and j=0 or 1), which are the control points. However, the present technique is different in that the mispositioning amounts are represented by the representative values of variation data for the respective positioning holes 150A (i.e., amounts of offsetting of positions of the positioning holes 150A) which representative values have been read out by the processing of the aforementioned step 400′.

When the substrate production processing described above finishes, the image-recording apparatus 100 relating to the present embodiment judges whether or not production of a predetermined number (herein, a number corresponding to one lot) of the PWBs 150 by the substrate production processing has been completed (step 504 in FIG. 12). If this judgment is negative, the image-recording apparatus 100 returns to the above-described step 502 and carries out production of the PWB 150 again. When the judgment is positive, this processing finishes.

With this second embodiment as described above, the same effects can be realized as with the first embodiment. In addition, deformation information representing a state of deformation of the printed wiring board just after etching has finished is preliminarily acquired. Therefore, when, in a sequential production process for successively producing a plurality of printed wiring boards, the deformation information is acquired for a predetermined number of initial printed wiring boards and this deformation information is used for producing the rest of the printed wiring boards, a duration from acquisition of the deformation information to production of the printed wiring boards can be shortened, as a result of which it is possible to produce the printed wiring boards in a shorter time.

For this second embodiment, a case in which the variation data after completion of the etching process is acquired on the basis of image capture by the cameras 164 has been discussed. However, the present invention is not limited thus. For example, a mode is also possible in which data acquired by an automated optical inspection (AOI) function of an automatic optical inspection device is applied as the variation data. In such a case, the same effects can be realized as in this second embodiment.

Further, in this second embodiment, a case has been described in which, in a sequential production process which successively produces a plurality of PWBs (here, a process of production of one lot of PWBs), the variation data representing a state of deformation of a PWB just after etching has finished is acquired for a predetermined number of initial PWBs and this variation data is used for producing the remainder of the PWBs. However, the present invention is not limited thus. It is also possible, in a sequential production process which successively produces a plurality of PWBs, to acquire variation data that represents a state of deformation of a printed wiring board just after a pressing process has finished for a predetermined number of initial PWBs, and use this variation data for producing the rest of the PWBs.

As a specific embodiment example of such a case, a mode which employs, instead of the variation data calculation processing relating to this second embodiment (FIG. 13), the substrate test production processing relating to the earlier-described first embodiment (FIG. 6) can be exemplified.

In such a case, if, in the sequential production process for successively producing a plurality of printed wiring boards, deformation information is acquired for the initial predetermined number of printed wiring boards and that deformation information is used for producing the rest of the printed wiring boards, it is possible to correct for offsetting of positions of recording of the wiring patterns with a state which includes two deformations, deformation due to etching and deformation due to pressing. Thus, in comparison with this second embodiment, it is possible to correct for mispositioning of recording more accurately.

Further, in the embodiments described above, cases have been described in which counter-deformation processing is carried out on raster data. However, the present invention is not limited thus. Modes are also possible which carry out counter-deformation processing on vector data.

FIG. 15 shows a block diagram of functions for performing control of exposure on the PWB 150 at the image-recording apparatus 100 relating to such a mode. Note that structural elements in FIG. 15 which perform processing the same as in FIG. 5 are assigned the same reference numerals as in FIG. 5.

As shown in FIG. 15, this case differs from the image-recording apparatus 100 relating to the first embodiment in that a substrate warping correction image-processing section 106′, which is interposed between the data preparation device 200 and the raster conversion processing section 104, is employed instead of the substrate warping correction image-processing section 106 interposed between the raster conversion processing section 104 and the image-recording control section 108. Here, the substrate warping correction image-processing section 106′ is structured to implement counter-deformation processing on vector data inputted from the data preparation device 200 in accordance with variation data obtained beforehand by the substrate test production processing (see FIG. 6), the variation data calculation processing (see FIG. 13) or the like.

Consequently, it is possible to carry out counterreformation processing on vector data with higher resolutions than raster data, and it is possible to correct for mispositioning of recording more accurately than in a case of carrying out conversions on raster data.

Furthermore, besides reflection-type spatial light modulation devices, such as the recording element units 166 equipped with digital micromirror devices which have been described as spatial light modulation devices for the above embodiments, it is possible to use transmission-type spatial light modulation devices (LCDs). For example, MEMS (microelectro-mechanical systems) type spatial light modulation devices (SLM: spatial light modulator); devices which modulate transmitted light by electro-optical effects, such as optical elements (PLZT elements), liquid crystal shutter arrays such as liquid crystal shutters (FLC) and the like, and the like; and spatial light modulation devices other than MEMS types may be utilized. Here, MEMS is a general term for Microsystems in which micro-size sensors, actuators and control circuits are integrated by micro-machining technologies based on IC fabrication processes. MEMS type spatial light modulation devices means spatial light modulation devices which are driven by electromechanical operations by utilization of electrostatic forces. Further, a spatial light modulation device which is structured to be two-dimensional by lining up a plurality of grating light valves (GLV) may be utilized. In structures which employ these reflection-type spatial light modulation devices (GLVs), transmission-type spatial light modulation devices (LCDs) and the like, beside lasers as mentioned above, lamps and the like may be employed as light sources.

Further, as a light source for the embodiments, it is possible to employ: a fiber array light source equipped with a plurality of multiplexed laser light sources; a fiber array light source in which fiber light sources, which are each equipped with a single optical fiber which outputs laser light inputted from a single semiconductor laser with a single light emission point, are arrayed; a light source in which a plurality of light emission points are two-dimensionally arranged (for example, a laser diode array, an organic electroluminescent array or the like); or the like.

Further still, the image-recording apparatus 100 of the embodiments may be suitably utilized for application to, beside exposure of a dry film resist (DFR) in a process for fabricating a printed wiring board as described above, formation of a color filter in a process for fabricating a liquid crystal display (LCD), exposure of a DFR in a process for fabricating a TFT, exposure of a DFR in a process for fabricating a plasma display panel (PDP), and the like.

Further again, although a case in which four of the positioning holes 150A are employed as the reference marks of the present invention has been described for the embodiments, the present invention is not limited thus, and modes in which five or more positioning holes are employed are also possible.

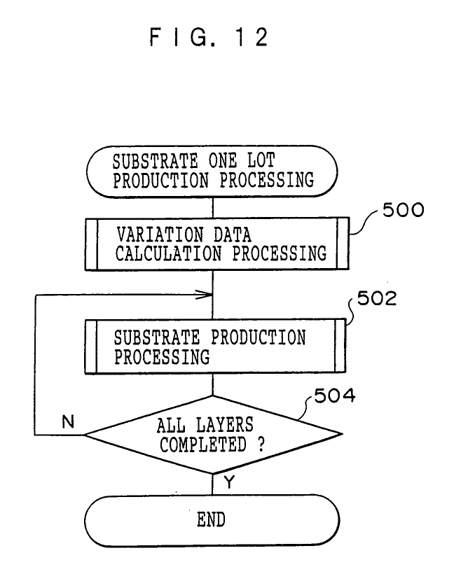

In particular, as shown by the example in FIG. 11, it is possible to provide the positioning holes 150A at eight locations at edge regions of the PWB 150, and to deal with barrel-form (or star-form) deformation by employing these positioning holes 150A as the reference marks of the present invention. Thus, more precise deformation processing is possible. In such a case, an imaginary positioning hole 150A is disposed centrally to the respective positioning holes 150A, with the total of nine positioning holes 150A dividing up four deformation quadrilateral regions and processing similar to that in the present embodiment being carried out for each of the divided regions.

Further yet, although a case in which counter-deformation processing is carried out for each lamination in the processing at a time of mass production of the PWB 150 (see FIG. 7) has been described for the embodiments, the present invention is not limited thus. For example, a mode is also possible in which the counter-deformation processing is carried out only for the first layer. For each of a second and subsequent layers, positions of the positioning holes 150A are detected and equation (2) is applied with the position information representing these positions serving as control points. Thus, the raster data is converted such that the wiring pattern to be recorded is deformed in accordance with a state of deformation of the PWB caused by lamination(s) up to the most recent lamination.

In such a case, for raster data which is the subject of recording onto a second or subsequent layer of the PWB, as shown by the example in FIG. 8, an image in the pre-deformation co-ordinate space is converted to an image in the post-deformation co-ordinate space. Specifically, pixel data of a point (u,v) in the pre-deformation image may be utilized as pixel data of a point S(u,v).

Accordingly, the deformation information of the ultimate recording medium is acquired in advance. For image information that is a subject of recording onto the first layer of the recording medium, the image information is converted in accordance with the acquired deformation information such that the recorded image will, at the ultimate recording medium, have the same shape as the image represented by the image information. For image information which is a subject of recording onto the second or a subsequent layer, the image information is converted so as to deform the image to be recorded in accordance with a state of deformation of the recording medium caused by lamination(s) up to the most recent lamination. For each layer of the recording medium, an image is recorded at the recording medium on the basis of the corresponding image information that has been converted by the converting means. By this process too, in a case in which the ultimate recording medium is produced by plurally laminating the recording medium and, at each lamination of the recording medium, the recording medium is deformed at the time of lamination, mispositioning of recording from ideal positions of the images is suppressed and it is possible to correct for mispositioning of recording of the images when the recording medium is deformed to an arbitrary shape.

Further again, although a case in which the positioning holes 150A are employed as the reference marks of the present invention has been described for the embodiments, the present invention is not limited thus. For example, modes in which other marks, such as grooves, symbols, letters, graphics or the like, represent the reference positions are also possible. In such cases, the same effects can be achieved as with the present embodiment.

Further still, although a case in which the correction for dealing with offsetting of the position of placement of the PWB 150 on the stage 152 is carried out has been described for the embodiments, the present invention is not limited thus. Modes in which this correction processing is not performed if an offset of the position of placement is within a predetermined range of tolerance, or the like, are also possible. In such cases, it is possible to reduce the load of calculations for performing the correction processing.

Further yet, although a case in which the counter-deformation processing is carried out using the FFD method has been described for the embodiments, the present invention is not limited thus. For example, modes are also possible in which counter-deformation processing is carried out using conventionally known affine conversions, co-linear conversions and the like. In such cases, similar effects can be achieved as with the embodiments.

Further again, the structure of the image-recording apparatus 100 described for the embodiments (see FIGS. 1 to 5) is an example. Obviously, suitable changes can be made within a scope that does not depart from the spirit of the present invention.

Moreover, in the image-recording apparatus 100 described for the present invention, the processing flow at the time of test production, the processing flow at the time of mass production, and the processing flows of the PWB lot production processing, the variation data calculating processing and the substrate production processing (see FIGS. 6, 7 and 12 to 14), are also examples. Obviously, suitable changes can be made within a scope that does not depart from the spirit of the present invention.

1. An image-recording apparatus which, in accordance with deformation of a recording medium at which an image represented by image information is to be recorded, converts the image and records the converted image at the recording medium, the apparatus comprising:
an acquisition section for preliminarily acquiring deformation information representing a state of deformation of the recording medium;
a conversion section for converting the image information, in accordance with the deformation information acquired by the acquisition section, such that the image recorded at the recording medium will, after deformation, have the same shape as the image represented by the image information; and
a recording section for, before deformation, recording the image at the recording medium on the basis of the image information that has been converted by the conversion section.

2. The image-recording apparatus of claim 1, wherein the recording medium is ultimately produced by plurally laminating the recording medium and, at each lamination of the recording medium, the recording medium is deformed at a time of lamination,
the acquisition section preparatorily acquires the deformation information of the recording medium for each lamination of the recording medium,
for each of sets of image information, which are subjects of recording onto a plurality of laminated layers of the recording medium, the conversion section converts the image information, in accordance with the deformation information of each lamination of the recording medium acquired by the acquisition section, such that the recorded images will, at the ultimate recording medium, have the same shapes as the images represented by the image information, and
at each layer of the recording medium, the recording section records the image at the recording medium, before a subsequent deformation, on the basis of the corresponding image information that has been converted by the conversion section.

3. The image-recording apparatus of claim 1, wherein the recording medium is ultimately produced by plurally laminating the recording medium and, at each lamination of the recording medium, the recording medium is deformed at a time of lamination,
the acquisition section preparatorily acquires deformation information of the ultimate recording medium,
for image information that is a subject of recording onto a first layer of the recording medium, the conversion section converts the image information, in accordance with the deformation information acquired by the acquisition section, such that the recorded image will, at the ultimate recording medium, have the same shape as the image represented by the image information, and for image information that is a subject of recording onto a second or subsequent layer of the recording medium, the conversion section converts the image information such that the image to be recorded is deformed in accordance with a state of deformation of the recording medium caused by each lamination up to a most recent lamination, and
for each layer of the recording medium, the recording section records the image at the recording medium on the basis of the corresponding image information that has been converted by the conversion section.

4. The image-recording apparatus of claim 1, wherein the deformation information acquired by the acquisition section comprises information representing directions and amounts of positional offsets, between before and after deformation of the recording medium, of a plurality of reference marks which are provided in advance at predetermined positions of the recording medium.

5. The image-recording apparatus of claim 4, wherein the reference marks are provided in advance for use in positioning at a time of image recording on the recording medium.

6. The image-recording apparatus of claim 4, wherein the reference marks are provided at at least four locations of the recording medium.

7. The image-recording apparatus of claim 4, wherein the reference marks are provided at vicinities of outer peripheral portions of the recording medium.

8. The image-recording apparatus of claim 1, wherein the conversion section converts the image information in accordance with the FFD method.

9. The image-recording apparatus of claim 1, wherein the recording medium comprises a printed wiring board, which is subjected to an etching process and a pressing process when recording of the image has been performed, and the image information represents a wiring pattern to be formed at the printed wiring board.

10. The image-recording apparatus of claim 9, wherein the acquisition section preliminary acquires deformation information representing a state of deformation of the printed wiring board just after the etching process has finished.

11. The image-recording apparatus of claim 9, wherein the acquisition section preliminary acquires deformation information representing a state of deformation of the printed wiring board just after the pressing process has finished.

12. The image-recording apparatus of claim 9, wherein the image information comprises vector data representing the wiring pattern.

13. The image-recording apparatus of claim 9, wherein the image information comprises raster data representing the wiring pattern.

14. An image-recording method for, in accordance with deformation of a recording medium at which an image represented by image information is to be recorded, converting the image and recording the converted image at the recording medium, the method comprising the steps of:
preliminarily acquiring deformation information representing a state of deformation of the recording medium;
converting the image information, in accordance with the deformation information, such that the image recorded at the recording medium will, after deformation, have the same shape as the image represented by the image information; and
recording the image at the recording medium before deformation on the basis of the image information that has been converted.
